(19) United States
(12) Patent Application Publication
(10) Pub. No.: US 2014/0313294 A1
(43) Pub. Date: Oct. 23, 2014

(54) DISPLAY PANEL AND METHOD OF DETECTING 3D GEOMETRY OF OBJECT

(71) Applicant: SAMSUNG DISPLAY CO., LTD., Yongin-City (KR)

(72) Inventor: David M. Hoffman, Fremont, CA (US)

(73) Assignee: SAMSUNG DISPLAY CO., LTD., Yongin-City (KR)

(21) Appl. No.: 14/252,580

(22) Filed: Apr. 14, 2014

Related U.S. Application Data
(60) Provisional application No. 61/814,751, filed on Apr. 22, 2013.

(51) Int. Cl. G06K 9/00; H04N 5/33; G06F 3/01; H04N 13/02; H04N 5/225

(52) U.S. Cl. CPC G06K 9/00604; H04N 13/0253; H04N 5/2256; H04N 5/2252; G06F 3/017; G06K 9/00617; H04N 5/33
USPC 348/47; 348/46

(57) ABSTRACT

A display panel includes: a plurality of pixels configured to display an image; at least one camera sensitive to a non-visible wavelength light and configured to have a field of view overlapping a front area of the display panel; and a plurality of emitters configured to emit light having the non-visible wavelength light in synchronization with exposures of the at least one camera.

### CROSS-REFERENCE TO RELATED APPLICATION

The present application claims priority to and the benefit of Provisional Application No. 61/814,751, filed on Apr. 22, 2013, titled “CREATION OF A NOVEL 3D GEOMETRY SCANNING SYSTEM BASED ON IR SHADING”, the entire content of which is incorporated herein by reference.

### FIELD

Aspects of embodiments of the present invention relate to a display panel and a method of detecting a 3D geometry of an object.

### BACKGROUND

Display devices are normally used as a device for conveying information from a computer system to an operator. Next generation displays will include new functionality in addition to presenting visual information. Furthermore, with the proliferation of cameras, displays can have an important role in enabling the cameras to acquire new types of data that previously have not been possible. Cameras and displays can together play an important role in acquiring important information about how the operator is using their display. This includes sensing new forms of gesture interaction with the computer system as well as authentication to confirm the identity of the operator.

### SUMMARY

Aspects of embodiments of the present invention relate to a display panel and a method of detecting a 3D geometry of an object.

According to aspects of embodiments of the present invention, a display panel includes: a plurality of pixels configured to display an image; at least one camera sensitive to a non-visible wavelength light and configured to have a field of view overlapping a front area of the display panel; and a plurality of emitters configured to emit light having the non-visible wavelength light in synchronization with exposures of the at least one camera.

The plurality of emitters may be configured to simultaneously emit the non-visible wavelength light by a subset of the emitters.

The plurality of emitters may be configured to be turned-on and turned-off only.

The at least one camera may include a plurality of cameras.

The plurality of cameras may be located at opposite edges of the display panel.

The at least one camera may include a wide-angle lens camera.

The display panel may further include a prism adjacent the at least one camera.

The display panel may further include a processor configured to use images captured from the at least one camera to estimate a 3D geometry of an external object.

The processor may be configured to estimate the 3D geometry of the object using shadings in the images of the object generated by the non-visible wavelength light from the emitters.

There may be a greater number of the pixels than the emitters.

The at least one camera may be configured for the field of view to extend in a direction generally parallel to a front surface of the display panel.

At least one of the emitters may be positioned at a display area including the pixels.

At least one of the emitters may be positioned at a periphery region of the display panel outside a display area including the pixels.

According to aspects of embodiments of the present invention, in a method of estimating a 3D geometry of an object in front of a display panel including at least one camera sensitive to a non-visible wavelength light, a plurality of display pixels and a plurality of emitters configured to emit the non-visible wavelength light, the method includes: illuminating the object with the non-visible wavelength light from the emitters in synchronization with exposures of the at least one camera; capturing non-visible wavelength light images of the object utilizing the at least one camera; and estimating the 3D geometry of the object utilizing the non-visible wavelength light images.

The illuminating the object may include emitting the non-visible wavelength light from subsets of the emitters located at different areas of the display panel.

The object may include an iris of an eye, and the emitting of the non-visible wavelength light may include emitting the non-visible wavelength light by the subsets of the emitters located at the different areas of the display panel to determine whether the iris matches a stored biometric data.

The emitters may be grouped into different subsets at different times.

The non-visible wavelength light images of the object may be captured while the plurality of display pixels are being used to display images unrelated to the object.

The estimating the 3D geometry of the object may include interpreting shading gradients of the object in the non-visible wavelength light images as 3D depths.

The at least one camera may include two cameras that are located at opposite edges of the display panel, and the capturing the non-visible wavelength light images may include capturing the non-visible wavelength light images simultaneously at the two cameras.

The at least one camera may include a field of view extending in a direction generally parallel to a front surface of the display panel.

The at least one camera may include a field of view extending in a direction generally perpendicular to a front surface of the display panel.

The method may further include comparing the estimated 3D geometry of the object with stored data; and determining whether the estimated 3D geometry of the object matches the stored data for biometrically identifying the object.

The stored data may include a data representation of a three-dimensional estimation of a user's face.

The method may further include unlocking access to an electronic device in response to determining the estimated 3D geometry of the object matches the stored data.

The method may further include determining whether the object includes a three-dimensional object or a two-dimensional image of the three-dimensional object.

### BRIEF DESCRIPTION OF THE DRAWINGS

The patent or application file contains at least one drawing executed in color. Copies of this patent or patent application publication with color drawings will be provided by the Office upon request and payment of the necessary fee.

A more complete appreciation of the present invention, and many of the attendant features and aspects thereof, will become more readily apparent with reference to the following detailed description when considered in conjunction with the accompanying drawings in which like reference symbols indicate like components, wherein:

FIG. 1 illustrates a 3D geometry detection system including a display device, according to some example embodiments of the present invention;

FIG. 2 illustrates details of a display device, according to some example embodiments of the present invention;

FIG. 3 illustrates a perspective view of a display device, according to some example embodiments of the present invention;

FIGS. 4A and 4B illustrate a perspective view and a side view of a display device and a field of view of a camera, according to some example embodiments of the present invention;

FIGS. 5A and 5B illustrate a perspective view and a side view of a display device having multiple cameras, according to some example embodiments of the present invention;

FIG. 6 illustrates an enlarged cross-sectional view of a portion of a display device, according to some example embodiments of the present invention;

FIG. 7 illustrates a perspective view of a display device having a front facing camera, according to some example embodiments of the present invention;

FIG. 8 illustrates images captured by a camera of an object illuminated by light sources located in various positions, according to some example embodiments of the present invention; and

FIGS. 9A and 9B illustrate a flow diagram of a process for 3D geometry scanning, according to some example embodiments of the present invention.

### DETAILED DESCRIPTION

Aspects of embodiments of the present invention relate to a 3D geometry detection system including a display device and method of detecting a 3D geometry of an object.

Aspects of embodiments of the present invention relate to leveraging non-visible wavelength light (e.g., infrared (IR) light) emitting pixels in a display panel for reconstructing or estimating the three-dimensional (3D) geometry of an object in front of the display panel. According to aspects of embodiments of the present invention, the display panel includes a series of relatively narrow-band non-visible wavelength light (e.g., IR) light emitters with independent control over each emitter or sub-portions of the emitters. By utilizing non-visible wavelength light emitters, aspects of embodiments of the present invention may estimate the 3D geometry of external objects while minimizing or reducing interference with the user's interaction with the display device. For example, the display device may display images using an array of pixels configured to emit visible images that are unrelated to external objects, and the user will not be able to see or detect the non-visible wavelength light emitted by the emitters.

The non-visible wavelength light emitters and camera may also capable of avoiding much of the ambient lighting. By using a narrow band non-visible wavelength light (e.g., IR) for the camera and a corresponding narrow band non-visible wavelength light emitter, the camera may spectrally filter out nearly all of the ambient light (e.g., light that originates from unintended sources such as room lighting, sunlight, and visible light from the display). The emitters can be constructed from high intensity discrete components (such as laser diodes, discrete LEDs) and used with or without a diffuser.

The non-visible wavelength light camera system may further mitigate the interference of ambient lighting by employing background subtraction. In background subtraction, in addition to the set of images captured with the various emitters active, one or more images may be captured with all emitters in their off state. This permits measuring the contribution of the non-controlled light sources and this baseline can be subtracted from the images with the emitters active.

Large groups of the emitters can be turned on to illuminate external objects with non-visible wavelength light (e.g., within the IR spectrum) from different directions in synchronization with exposure times of one or more cameras having a narrow-hand spectral sensitivity corresponding to the wavelength of light emitted by the emitters. The cameras capture images of external objects from the non-visible wavelength light emitted by the emitters and reflected off the external objects. The non-visible wavelength light emitted by the emitters and reflected back to the cameras will have a different brightness or shading based on the angle between the emitter and the surface normal of the object. Based on the images of the objects illuminated from various known positions and the corresponding brightness or shading gradients of the light reflected off the object, the 3D geometry of the surfaces of the object can then be estimated or calculated, for example, through inverse shading analysis.

The cameras may have a forward-facing (e.g., perpendicular with respect to the surface of the display panel) field of view, which may facilitate capturing high resolution images of a user's face, iris, or other biometric authentication features. Alternatively, the cameras may have a field of view extending substantially parallel across a surface of the display device, which may facilitate capturing movements and gestures of users for the purposes of interacting with and controlling the display device.

The use of the IR camera and adaptive illumination allows for estimating the 3D geometry of objects that are near the display but beyond a distance in which they may be detected by a touch or hover sensor, which may further enable gestures or motions of users to be detected and utilized for controlling the display panel or computer systems.

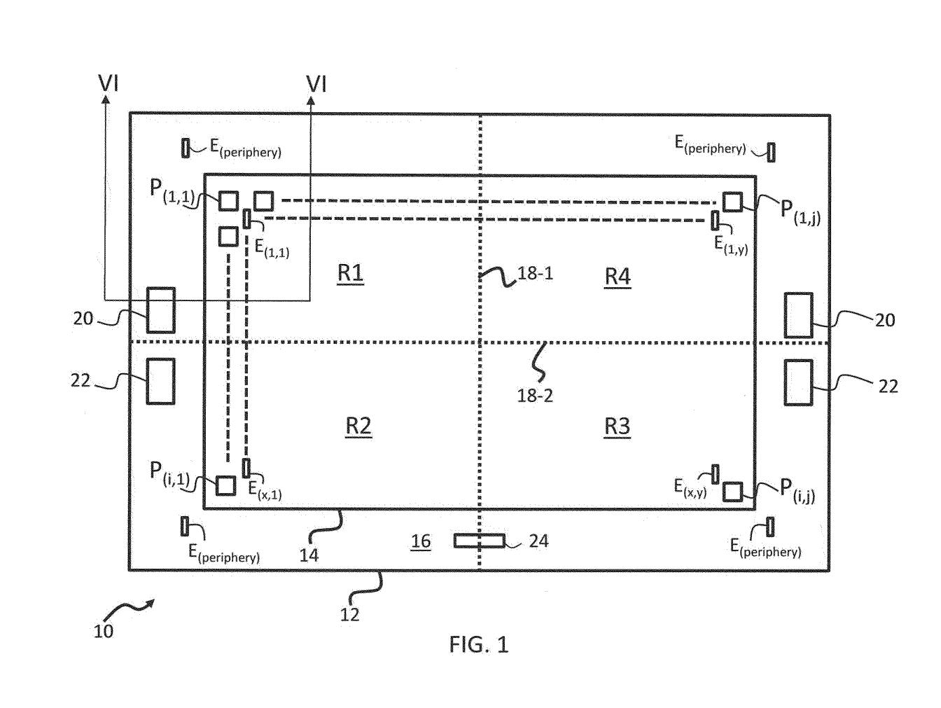

Referring to the figures, FIG. 1 illustrates a 3D geometry detection system 10 including a display device 12 according to embodiments of the present invention. As shown in FIG. 1, the display device 12 includes a display 14 having a pixel array including a plurality of pixels P_{(1,1)} through P_{(i,j)}, including i rows and j columns. The number of pixels P_{(1,1)} through P_{(i,j)}. according to the design and size of the display device 12.

Additionally, the display device 12 includes a non-visible light emitter array. For example, in one embodiment, the display device 12 includes a plurality of pixels or emitters E_{(1,1)} through E_{(x,y)}, including x rows and y columns interspersed between the pixels P_{(1,1)} through P_{(i,j)}. The number of emitters E_{(1,1)} through E_{(x,y)} may vary according to the design and size of the display device, and may be less than the number of pixels P_{(1,1)} through P_{(i,j)} for displaying an image. In some example embodiments, the one of the emitters E_{(1,1)} through E_{(x,y)} is positioned between two adjacent ones of the pixels P_{(1,1)} through P_{(i,j)} and aligned within the rows or columns of the pixels P_{(1,1)} through P_{(i,j)}. Alternatively, the emitters E_{(1,1)} through E_{(x,y)} may be positioned between the rows and columns of the pixels P_{(1,1)} through P_{(i,j)}.

The display device 12 may further include a plurality of emitters E_{(periphery)} positioned at a periphery region (or bezel) 16 outside of the display 14. The number of emitters E_{(periphery)} vary according to the design and size of the display device 12. The emitters E_{(periphery)} may be positioned along edges of the display 14 (e.g., the bezel), or may be positioned at each corner of the display 14 according to the design of the display device 12. While both the pixel emitters E_{(1,1)} through E_{(x,y)} and the periphery emitters E_{(periphery)} are shown in the display device 12, the present invention is not limited thereto, and the display device 12 may include only some of the emitters. Additionally, the pixel emitters E_{(1,1)} through E_{(x,y)} and the periphery emitters E_{(periphery)} may be arranged as or constitute an active or passive matrix of pixels emitting non-visible wavelength light, in which a subset of the emitters are configured to simultaneously or concurrently emit the non-visible wavelength light. The emitters E_{(1,1)} through E_{(x,y)} and the periphery emitters E_{(periphery)} may additionally be configured to be turned-on and turned-off only, such that the emitters emit a relatively consistent and uniform brightness or intensity of the non-visible wavelength light when turned on, and do not emit light when turned off.

The pixels P_{(1,1)} through P_{(i,j)} may include any suitable pixel circuit and visible light emitting element according to the design and function of the display device 12 to enable the display of images on the display device 12. For example, the pixels P_{(1,1)} through P_{(i,j)} may each include one or more organic light emitting diodes (OLEDs) configured to emit visible light according to the RGB color model based on signals received by the pixel circuits of the pixels P_{(1,1)} through P_{(i,j)}. By contrast, the emitters E_{(1,1)} through E_{(x,y)} and the emitters E_{(periphery)} each include an emission pixel circuit configured to emit light with a non-visible wavelength. In one embodiment, the emitters E_{(1,1)} through E_{(x,y)} and the emitters E_{(periphery)} are configured to emit non-visible light within the infrared wavelength spectrum (e.g., greater than about 700 nanometers (nm)). In one embodiment, the emitters E_{(1,1)} through E_{(x,y)} and the emitters E_{(periphery)} are configured to emit light at a wavelength of approximately 940 nm, which may facilitate 3D geometry detection of objects in outdoor uses due to atmospheric moisture absorbing background light from the sun. In other embodiments, the emitters E_{(1,1)} through E_{(x,y)} and the emitters E_{(periphery)} are configured to emit light at a wavelength of approximately 800 nm, which may facilitate 3D geometry detection for the purposes of biometric authentication. The wavelength range is also selected for its relative constancy of reflectiveness across skin tones.

The display device 12 is partitioned into a plurality of regions R1 through R4 (defined by boundaries 18-1 and 18-2, which run vertically and horizontally, respectively, through the center of the display device 12), although the number, size, shape, and location of the regions may vary according to the design of the display device 12. The emitters E_{(1,1)} through E_{(x,y)} and/or the emitters E_{(periphery)} positioned within each of the regions R1 through R4 are configured to emit light concurrently with other emitters positioned within the same region, in order to illuminate an external object from different angles.

The display device 12 includes one or more cameras 20 positioned at the periphery region 16, which are capable of detecting light at the same wavelength emitted by the emitters, and for which the exposure time can be synchronized with the emission of light from the emitters. In one embodiment, the cameras 20 are configured to detect and capture images from light within the non-visible infrared wavelength spectrum (e.g., a narrow bandwidth coinciding with the narrow bandwidth of non-visible wavelength light emitted by the emitters, such as 800 nm) according to the design of the display device 12 and the spectrum of light emitted by the emitters E_{(1,1)} through E_{(x,y)} and the emitters E_{(periphery)}. In another embodiment, the cameras are configured to detect and capture images from light at a wavelength of approximately 940 nm. The number and position of the cameras 20 may vary according to the design and function of the display device 12. For example, a single camera 20 may be positioned at one edge of the display device 12, or multiple ones of the cameras 20 may be positioned at opposite edges (or opposite sides) of the display device 12 or at various locations around the periphery region 16.

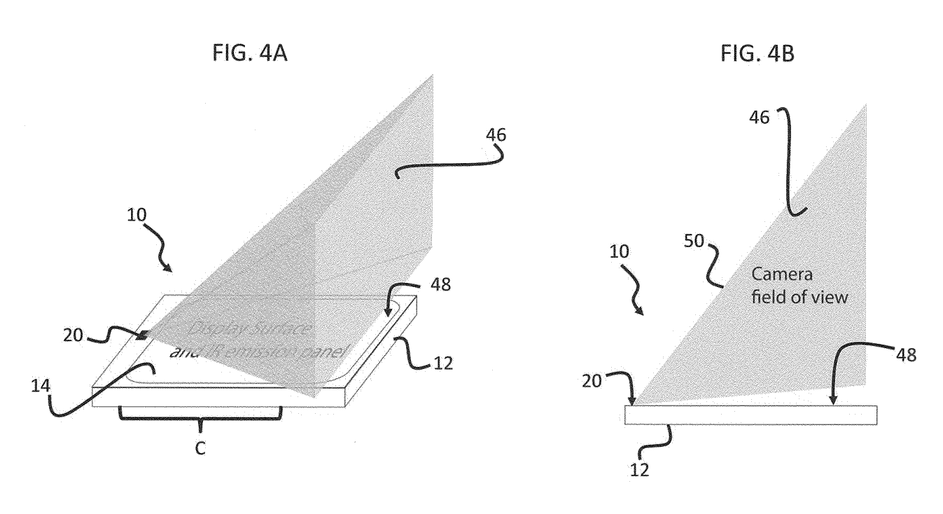

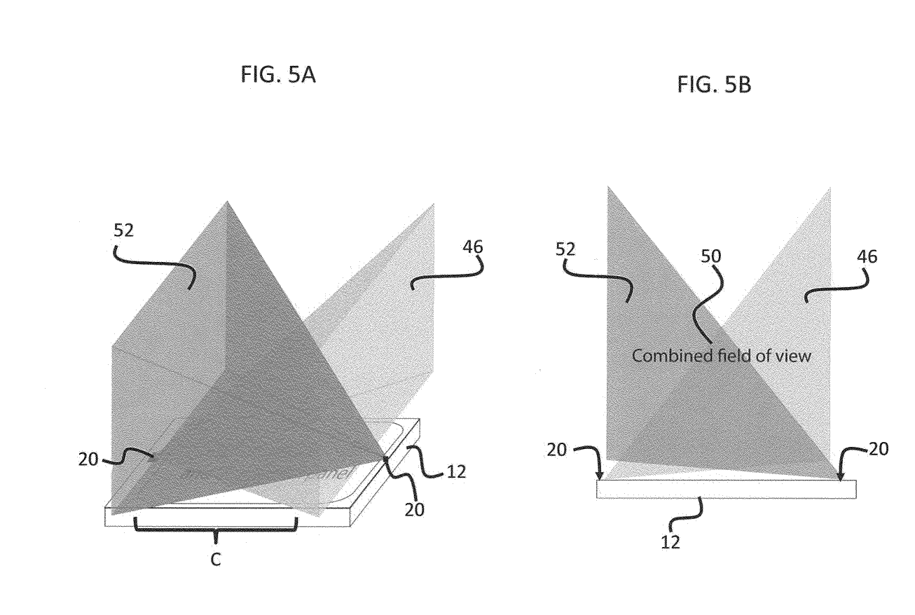

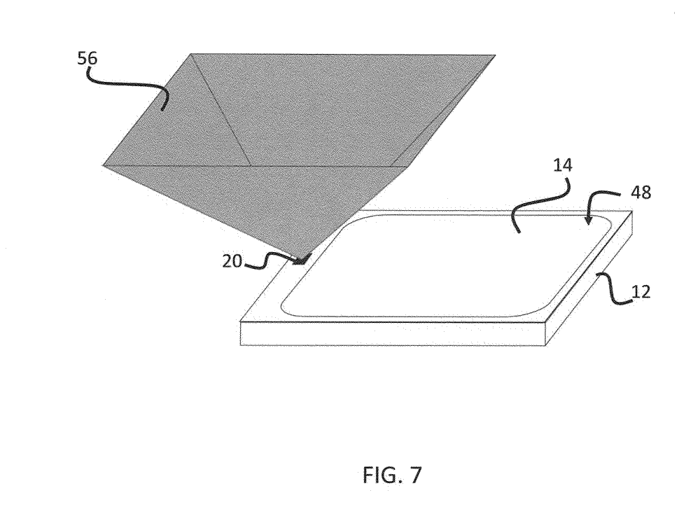

Additionally, as will be discussed with respect to FIGS. 4A-4B, 5A-5B, and 7 below, the field of view of the cameras 20 may vary according to the design of the display device 12. For example, in one embodiment, the cameras 20 may be directed across the surface of the display device 12 such that the field of view of the cameras 20 extends in a direction generally parallel or horizontal with respect to the surface of the display device 12 (see, e.g., FIGS. 4A-4B and 5A-5B) and may generally or substantially overlap an area in front of the display 14. In another embodiment, the cameras 20 may be forward-facing and directed perpendicularly with respect to the surface of the display device 12 (see, e.g., FIG. 7). In other embodiments, both types of cameras may be included.

As will be discussed in further detail below, embodiments of the present invention enable the display device 12 to emit non-visible wavelength light from the emitters E_{(1,1)} through E_{(x,y)} and the emitters E_{(periphery)} to illuminate an external object from various angles or perspectives corresponding to a plurality of regions R1 through R4, and concurrently (e.g., in synchronization with light emitted from the emitters) capture an image of the external object using the cameras 20. The 3D geometry detection system 10 can then calculate or detect a 3D geometry of the external object based on the shading and brightness of the light reflected from the external object and captured by the cameras 20 from the images captured by the cameras 20. Accordingly, the emitters E_{(1,1)} through E_{(x,y)} and the emitters E_{(periphery)} are tuned to emit non-visible wavelength light with a relatively narrow bandwidth, and the cameras 20 are tuned to be sensitive to the same or similar relatively narrow bandwidth. Additionally, the emission time by the emitters E_{(1,1)} through E_{(x,y)} and the emitters E_{(periphery)} may be relatively short, for example, less than 2 milliseconds (ms), to adjust exposure, reduce blurriness of images captured by the cameras 20, reduce the time delay between the images in a series of images corresponding to each illumination region, and the exposure time of the cameras 20 is timed to correspond to the emission time by the emitters.

In addition to the cameras 20 for capturing light within a non-visible wavelength spectrum (e.g., IR cameras), the display device 12 may further include one or more visible light cameras 22 for capturing images of objects within the visible light spectrum. The number and location of the cameras 22 may vary according to the design of the display device 12. The display device 12 may additionally include one or more buttons or keys 24 as a hardware interface for users of the display device 12 to interact with and control the display device 12. Additionally, the display 14 of the display device may include touch sensors for detecting positions of locations touched on the display 14 for enabling users to interact with and control the display device 12.

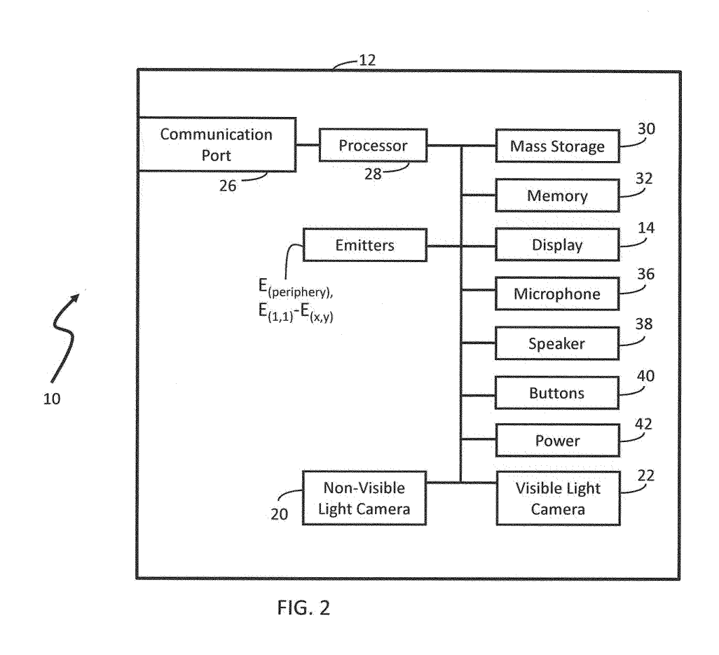

FIG. 2 illustrates further detail of an example display device 12 according to embodiments of the present invention. The display device 12 includes a communication port 26, for sending and receiving data signals to other electronic devices. The communication port 26 represents one or more electronic communication data ports capable of sharing input and output data with external devices. Communication port 26 can be configured to couple to data cable connectors with a wired interface such as high-speed Ethernet, Universal Serial Bus (USB), High-Definition Multimedia Interface (HDMI), or other similar analog or digital data interface. Alternatively, communication port 26 may be configured to receive and transmit input and output (I/O) data wirelessly, for example, using available electromagnetic spectrum.

The communication port 26 is in electronic communication with a processor 28 of the display device 12 for processing data received by the communication port 26 and for transmitting data processed by the processor 28 to external devices.

The display device 12 further includes several other components that are controlled by the processor 28. For example, mass storage device or hard disk 30 is electrically connected to the processor 28 for storing data files on non-volatile memory for future access by the processor 28. The mass storage device 30 can be any suitable mass storage device such as a hard disk drive (HDD), flash memory, secure digital (SD) memory card, magnetic tape, compact disk, or digital video disk. The display device 12 further includes electronic memory 32 for addressable memory or RAM data storage. Collectively, the processor 28, the mass storage device 30, and the electronic memory 32 may operate to facilitate gameplay of a video game session on the electronic device, such that the electronic memory 32 operates as a computer-readable storage medium having non-transitory computer readable instructions stored therein that when executed by the processor 28 cause the processor 28 to control an electronic video game environment according to user input received through the display device 12.

The display 14 is positioned externally on the display device 12 to facilitate user interaction with the display device 12. The display 14 may be a liquid crystal display (LCD), organic light emitting diode (OLED) display, or other suitable display capable of graphically displaying information and images to users within the visible light wavelength spectrum. In one embodiment, the display is a touch screen display capable of sensing ₜouch input from users. The display 14 includes the plurality of pixels P_{(1,1)} through P_{(i,j)} for displaying visible images to users, and further may include the plurality emitters E_{(1,1)} through E_{(x,y)} and/or the emitters E_{(periphery)} for emitting non-visible light as discussed above, or the plurality emitters E_{(1,1)} through E_{(x,y)} and/or the emitters E_{(periphery)} may be outside of the area of the display 14.

The display device 12 further includes a microphone 36 and a speaker 38 for receipt and playback of audio signals. One or more buttons 24 (or other input devices such as, for example, keyboard, mouse, joystick, etc.) enable additional user interaction with the display device 12. The display device 12 further includes a power source 42, which may include a battery or may be configured to receive an alternating or direct current electrical power input for operation of the display device 12.

Additionally, the display device 12 further includes the non-visible light cameras 20 (e.g., infrared light cameras) for detecting and capturing images from non-visible light, and the visible light cameras 22 for detecting and capturing images from visible light. In other embodiments, the display device 12 may include one or more but not all of the components and features shown in FIGS. 1 and 2, or some of the components may be included in other electronic devices in electronic communication with the display device 12.

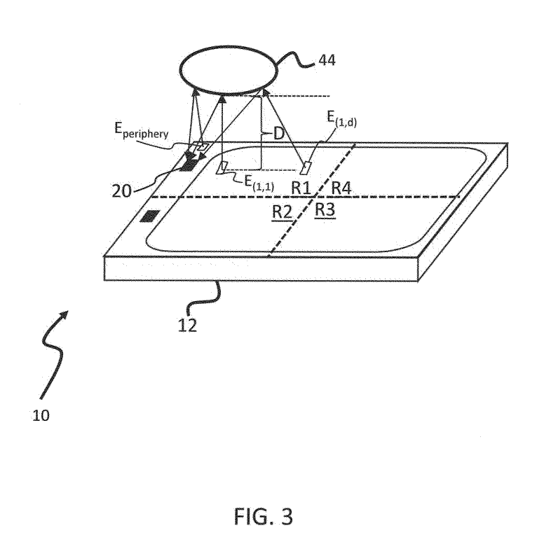

FIG. 3 illustrates a perspective view of the display device 12 during emission of non-visible light from one of the regions R1. During operation of the display device 12, the 3D geometry detection system 10 may perform a process for detecting, calculating, or estimating the 3D geometry of an external object 44. For example, the external object 44 may be a user's face or retina, and the 3D geometry detection system 10 may perform a 3D geometry detection process to detect or verify biometric data regarding a user's physical characteristics (e.g., retina, iris, or facial detection) for the purposes of allowing the user to access data stored by or accessible from the display device 12. Additionally, the 3D geometry detection system 10 may perform a 3D geometry detection process to determine or verify that an object is actually a three-dimensional object as opposed to a two-dimensional photograph of a three-dimensional object. As another example, the external object 44 may also be a user's hand or finger, and the 3D geometry detection system 10 may perform a 3D geometry detection process to detect or sense gestures performed by a user during interaction with the display device 12.

During the 3D geometry detection process, the display device 12 emits non-visible light from the emitters in one region at a time. For example, as shown in FIG. 3, the display device 12 emits light from the emitters located in the region R1. The display device 12 concurrently synchronizes an exposure time of the camera 20 with the emission of light by the emitters located in the region R1 such that the light emitted from the emitters and reflected off the object 44 is captured by the camera 20 and stored as an image. Depending on the curvature, reflectivity, and surface orientation of the object 44, the brightness of light captured by the camera reflected off different portions of the object 44 will vary, causing an intensity or brightness gradient according to the local surface orientation of the object 44. For example, the camera will detect the brightest reflections from regions of the object whose local surface normal is directed towards the light source, or the surface is perpendicular to the light direction. When the surface is parallel to the light source, it will reflect no light from the light source. The intensity will also be related to the distance from the light source to the object, with rapid fall off at larger distances (fourth power of distance relationship).

When the distance D between the object 44 and the display device 12 is small, the amount of light reflected back to the camera may be high enough to cause an overexposed image, which may interfere with or reduce the effectiveness of the 3D geometry detection process. On the other hand, when the distance D between the object 44 and the display device 12 is large, the amount of light reflected back to the camera 20 may be too low, which may cause an underexposed image that may interfere with or reduce the effectiveness of the 3D geometry detection process.

Therefore, according to some example embodiments of the present invention, the 3D geometry detection system 10 may emit light by the emitters positioned in the region R1 while concurrently capturing an image of the object 44 by the camera 20, and then determine whether the image of the object 44 is overexposed or underexposed. If the 3D geometry detection system 10 determines that the object 44 is overexposed or underexposed, the 3D geometry detection system 10 may adjust the brightness of the emitters in the region R1, the duration of the emitter flash in the region R1, or the exposure time of the camera 20, and then repeat the emission and image capturing process for the object 44 with respect to the region R1. For example, when the 3D geometry detection system 10 determines that the object 44 is overexposed, then the emission brightness by the emitters may be decreased, or the exposure time of the camera 20 may be decreased. When the 3D geometry detection system 10 determines that the object 44 is underexposed, then the emission brightness by the emitters may be increased, the duration of the emitters may be increased, the area of the emitter region or number of discrete emitters may be increased, or the exposure time of the camera 20 may be increased.

The emission of light and capturing of an image with respect to the region R1 may be repeated and adjusted until the 3D geometry detection system 10 determines that the object 44 is appropriately exposed for calculating or detecting the 3D geometry of the object 44. Once the 3D geometry detection system 10 determines that the exposure of the object 44 is appropriate with respect to the region R1, the 3D geometry detection system 10 causes the emitters in the region R2 to emit light like those of the region R1, during which the camera 20 concurrently captures an image. The same process is then performed for the other regions (e.g., regions R3 and R4) until an image is captured by the camera 20 of the light reflected from the object 44 corresponding to each of the regions of the display device 12. The images are stored in the memory 32, and a suitable 3D geometry detection algorithm is performed based on the images to calculate or estimate a 3D geometry of the object 44 (e.g., by generating a depth map or 3D point cloud corresponding to the object 44).

In situations in which there is strong ambient lighting, the 3D geometry detection system 10 may capture an additional image with no emitters on. This image will serve as the baseline and can be subtracted from the images with an active emitter to negate the influence of ambient light.

In some example embodiments, the 3D geometry detection system 10 may be able to accurately and effectively detect the 3D geometry of external objects 44 when a distance D between the object 44 and the display device 12 is greater than a minimum distance and less than a maximum distance. For example, in some example embodiments, the operating distance D may be greater than 30 millimeters (mm) and less than 400 mm. At far distances, the 3D geometry detection system 10 may be less sensitive to the diminishing amount of reflected light from the object 44. At short distances, the 3D geometry detection system 10 may not be able to detect objects due to the geometry of camera 20 field of view and spacing of the emitters. In some example embodiments, the operating distance D may be greater than 10 centimeters (cm) and less than 40 cm. The operating distance D may vary according to the design and function of the 3D geometry detection system 10, for example, by varying the location, sensitivity, or exposure time of the camera 20, or by varying the location, number, and emission intensity of the emitters.

FIGS. 4A.and 4B illustrate a perspective view and a side view of a display device 12 of the 3D geometry detecting system 10 having a single camera 20 for detecting emitted light according to some example embodiments of the present invention. As shown in FIG. 4A, the camera 20 has a field of view 46 that extends away from the camera 20 across a surface 48 of the display 14. Light reflected off external objects and gestures within the field of view 46 of the camera 20 may be reflected back to the camera for detecting or calculating the 3D geometry of the external objects or gestures according to the design of the 3D geometry detection system 10.

The size and angle of the field of view 46 of the camera 20 may vary according to the design of the display device 12. For example, in some example embodiments, the camera 20 may have a field of view of approximately 30 degrees. In some example embodiments, the camera 20 may be a wide-angle or fisheye camera having a relatively wide field of view (e.g., greater than 90 degrees). Depending on the field of view 46 of the camera 20, however, certain portions of the surface 48 of the display 14 may not overlap with the field of view 46 of the camera 20. Therefore, objects or gestures located, for example, in the corner region C close to the camera 20 may not be within the field of view of the camera 20. Additionally, objects or gestures located further away from the display device 12, for example, vertically above the upper edge 50 of the field of view 46 shown in FIG. 4B, may be outside of the field of view of the camera 20.

Accordingly, the number and location of the cameras 20 may vary according to the design of the display device 12, such that the collective field of view of the cameras 20 overlaps a greater surface area of the display 14 or the display device 12, and the cameras 20 can more effectively detect light reflected from objects further away from the display device 20. For example, as illustrated in FIG. 5A, the display device 12 may include two or more cameras 20 positioned at opposite edges (or opposite sides) of the display device 12. Accordingly, a field of view 52 of a second camera 20 may overlap with the corner region C of the display 14 that is not within the field of view 46 of the first camera 20. Additionally, the field of view 52 may also cover portions of the region vertically above the upper edge 50 of the field of view 46. Accordingly, by increasing the number of cameras, the collective fields of view (e.g., the combination of the fields of view 46 and 52) of the cameras 20 may be larger than with fewer cameras. Additionally, increasing the number of cameras 20 may reduce the incidence of self-occlusion with respect to external objects that may occur when portions of the object block light from reflecting back to the cameras 20 from other portions of the object. In another embodiment, the cameras 20 may include fisheye cameras, wide-angle cameras, or ultra wide-angle cameras to further increase the field of view of the cameras 20.

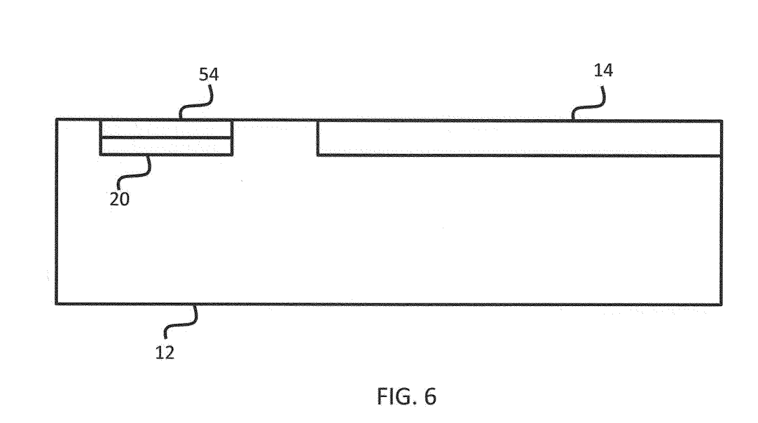

FIG. 6 illustrates an enlarged cross-sectional view of the display device 12 taken along the line VI-VI of FIG. 1. As shown in FIG. 6, the display device 12 may additionally include a prism 54 or other optical component mounted over or adjacent the cameras 20. The prism 54 may alter the angle of the fields of view 46 and 52 of the cameras 20, such that the fields of view 46 and 52 are directed across the surface of the display device instead of away from the display device 12 in a perpendicular direction.

As shown in FIG. 7, one or more of the cameras 20 may be a front-facing camera, in which the field of view is directed perpendicularly with respect to the surface 48 of the display 14. The front facing camera 20 may have a relatively narrow field of view to facilitate detecting objects or gestures directly above the camera 20. For example, in the concept of biometric data detection (e.g., iris verification) or facial expression detection, the front-facing camera 20 may enable users to more easily interact with the camera, allow objects to be further away from the camera 20, or facilitate identifying custom gestures, sign-language, pointing, or other gestures performed by user over the camera 20.

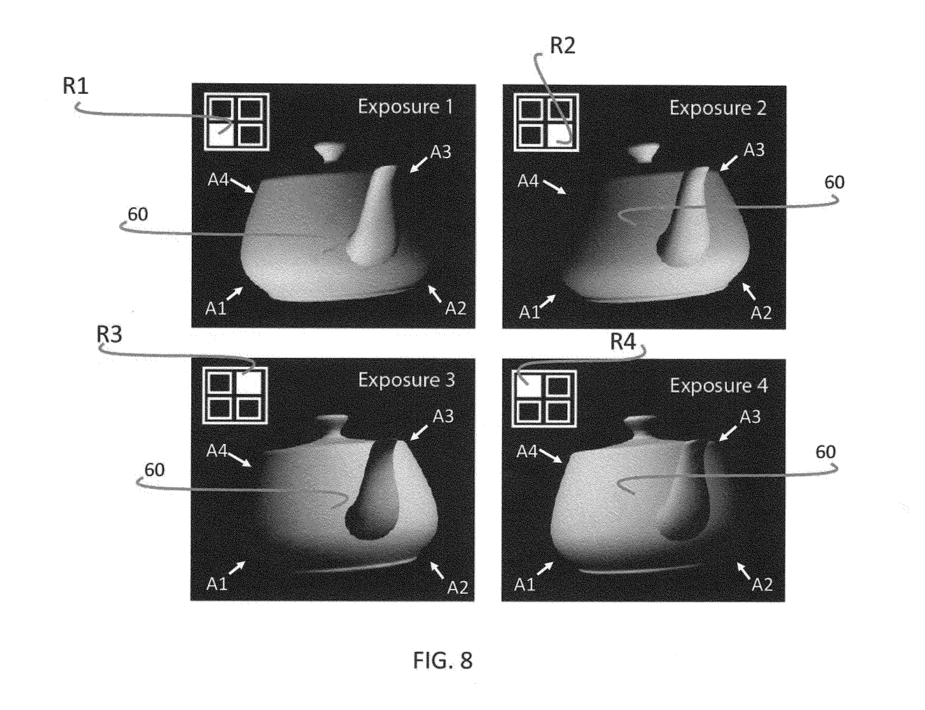

FIG. 8 illustrates exposures or images of light captured by the camera 20 for different regions of the display device 12 according to some example embodiments of the present invention. As shown in FIG. 8, each of the exposures 1-4 illustrates images corresponding to the regions R1-R4 respectively shown, for example, in FIG. 1. The exposures 1-4 each show an image of an object 60 captured by one or more of the cameras 20 in which the object is illuminated by the emitters in a different region for each exposure. For example, the exposure I corresponds to the region R1, and illustrates an image captured by the cameras 20 concurrently with non-visible light being emitted by the emitters within the region R1. Similarly, the exposures 2-4 correspond to the regions R2 through R4, and illustrate images captured by the cameras 20 concurrently with non-visible light being emitted by the emitters with the regions R2 through R4, respectively.

As illustrated in FIG. 8, the object 60 is illuminated from different perspectives for each of the exposures 1-4. Surfaces of the object 60 that are more orthogonal to the emitters illuminating the object are brighter because a higher amount of the non-visible light is reflected back to the cameras 20 during the exposure period. For example, for the exposure 1, the area Al of the object 60 is generally more brightly illuminated than the areas A2-A4 of the object 60, because the area Al is generally more orthogonal to (e.g., faces more toward) the region R1. As the curvature of the object changes, moving, for example, toward the areas A2 and A4, less light is reflected back to the cameras 20, causing a gradient effect with respect to the brightness of the light reflected off of the object 60 and captured by the cameras 20. Moving toward the region A3, the brightness of the light reflected off the object 60 decreases further, and the curvature of the object 60 may cause portions of the object 60 to be entirely obstructed by other portions of the object 60 (self occlusion) and preventing or substantially preventing light emitted by the emitters in the region R1 from reflecting back to the cameras 20.

For each of the other exposures 2-4, the brightness gradient of the light reflected by the object 60 varies according to the position of the emitters. For example, the area A2 is generally more orthogonal to the region R2 than the areas A1, A3, and A4, and therefore generally more light emitted by the emitters in the region R2 is reflected back to the cameras 20 during the exposure time for the exposure 2. The area A3 is generally more orthogonal to the region R3 than the areas A1, A2, and A4, and therefore generally more light emitted by the emitters in the region R3 is reflected back to the cameras 20 during the exposure time for the exposure 3. The area A4 is generally more orthogonal to the region R4 than the areas A1-A3, and therefore generally more light emitted by the emitters in the region R4 is reflected back to the cameras 20 during the exposure time for the exposure 4.

Thus, as illustrated in FIG. 8, the 3D geometry detection system 10 according to embodiments of the present invention, is configured to emit light from various regions on the display device 12 concurrently with an exposure time of one or more cameras 20 positioned on the display device 12 such that separate images of external objects are captured for each region. The number, size, and location of the regions may vary according to the design of the display device 12, but by illuminating the object from various perspectives and capturing images of the object when it is illuminated from the different perspectives, the brightness gradients illustrated in the images reflect the three-dimensional geometry of the object. Based on the brightness gradients in the images, the three-dimensional geometry of the object can therefore be estimated or calculated using a suitable algorithm for creating three-dimensional renderings of objects based on shading that is well-known to one of ordinary skill in the art. For example, there are a large number of widely disseminated algorithms for estimating the orientation of surfaces from the light gradients, and integrating these surfaces into a shape (see, e.g., “Shape from Shading: A Survey,” Ruo Zhang, Ping-Sing Tsai, James Cryer and Muvarak Shah, IEEE TRANSACTION ON PATTERN ANALYSIS AND MACHINE INTELLIGENCE (1999, vol. 21, 8)). By knowing where the light is coming from, and what regions of the external object are bright compared to other regions, it is possible to estimate the orientation of the surfaces of the object with respect to the light sources.

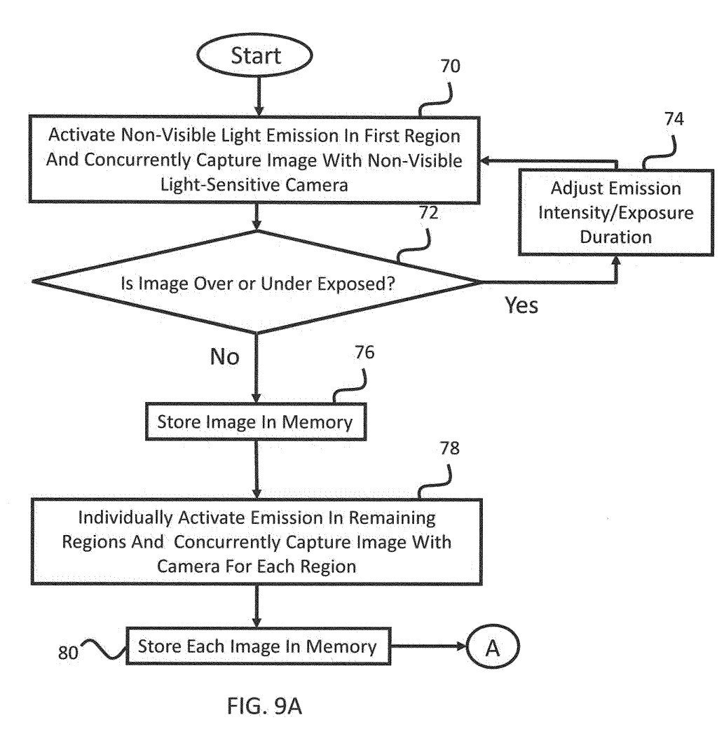

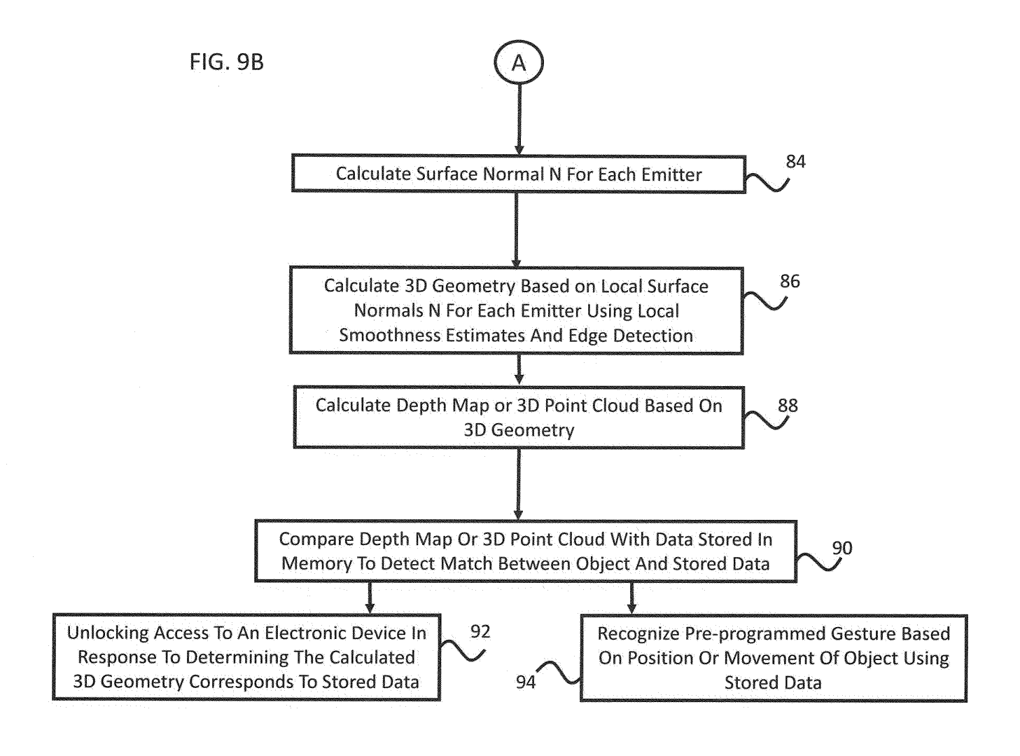

Once the images corresponding to each of the regions R1-R4 are captured, the 3D geometry detection system 10 ensures that the images are aligned with respect to the position of the object relative to the display device 12, and by interpreting the shading or brightness gradients as three-dimensional depths, calculates the three-dimensional geometry of the object. FIGS. 9A and 9B show a flow diagram of a process for 3D geometry detection, according to some example embodiments of the present invention. The process may be described in terms of a software routine executed by a processor (e.g., the processor 28) based on instructions stored in memory (e.g., memory 32). The instructions may also be stored in other non-transient computer readable media such as, for example, a CD-ROM, flash drive, or the like. A person of ordinary skill in the art should also recognize that the routine may be executed via hardware, firmware (e.g., via an ASIC), or in any combination of software, firmware, and/or hardware. Furthermore, the sequence of blocks of the processes are not fixed, but can be altered into any desired sequence as recognized by a person of skill in the art. Additionally, some or all of the steps may be performed by external computer systems (e.g., in electronic communication with the display device 12) according to the design of the 3D geometry detection system 10.

Each time the 3D geometry of an object (e.g., object 44) is to be detected by the 3D geometry detection system 10, the process starts, and in block 70, the 3D geometry detection system 10 activates non-visible light emission from the emitters in a first region and concurrently captures an image with a non-visible light-sensitive camera. The exposure time of the non-visible light-sensitive camera may vary according to the design of the 3D geometry detection system 10 and the distance of external objects.

In block 72, the 3D geometry detection system 10 determines whether the image is over or under exposed. In response to determining that the image is over or under exposed, the 3D geometry detection system 10, in block 74, adjusts the emission intensity of the non-visible wavelength light emitted by the emitters in the first region, or adjusts the exposure duration of the cameras. Increasing the emission intensity, however, eventually may consume enough additional power to interfere with the efficiency and operation of the 3D geometry detection system 10. Additionally, increasing the exposure duration of the camera may cause images to become blurry (e.g., when the external object is moving, or there is some shake of the display device) or may cause the camera to capture too much light from other light sources, which may interfere with the efficiency and operation of the 3D geometry detection system 10, or may introduce too large an interval between subsequent captures to align a moving object across the series of images.

After adjusting the emission intensity or exposure duration according to block 74, the 3D geometry detection system 10 returns to block 70 to again activate non-visible light emission from the emitters in a first region and concurrently captures an image with a non-visible light-sensitive camera, followed by determining whether the image is over or under exposed according to block 72. The process of blocks 70-74 is repeated until the image corresponding to the first region of the emitters is not over or under exposed, and the 3D geometry detection system 10 proceeds, in block 76, to store the image corresponding to the first region in memory.

The 3D geometry detection system 10 then, in block 78, individually activates non-visible wavelength light emission from emitters in each of the remaining regions of the display device 12 and concurrently captures images for each of the regions by the camera. Optionally, the 3D geometry detection system 10 may capture one image with all emitters off for use in ambient light background subtraction. In block 80, the 3D geometry detection system 10 stores the images corresponding to the remaining regions in memory.

Referring to FIG. 9B, the 3D geometry detection system 10 continues, in block 82, with calculating a surface normal N for each emitter or each region based on the known illumination vector from the emitter or region of emitters and a constant reflection magnitude, for example, according to the following equation (1) below:

I_{pix(X,i,j)}=Illum_{mag}*Reflect_{const•}N_{(i,j)}•Illum_{vec}(X,i,j) (1)

where I_{pix(x,i,j)} is pixel value associated for each position on the sensor (i,j) and each exposure X, Illum_{mag} is the illumination magnitude which is directly related to the power and distance of the emitter, Reflect_{const} is the reflectivity which is typically constant regardless of angle (and in infrared is fairly constant across different skin tones), N_{(i,j)} is the 3D surface normal for the surface being imaged by the camera at pixel i,j (which is constant irrespective of the direction of illumination), and Illum_{vec} is the unit illumination vector that describes the average angle of the emitter when it reaches the object surface at location i,j in each exposure X.

The dot product of these two vectors will be largely responsible for the magnitude of the reflected light. The illumination vector is approximately known by the controller as it controls the emitter location. The reflectivity constant is invariant to direction. For moderate distances and well calibrated emitters, the illumination magnitude is constant for each image. It is therefore possible to solve a system of equations produced by 3 or more emitter directions to estimate the surface normal (N) for each location in the image.

Once the surface normal N is calculated for each emitter or emitter region, the 3D geometry detection system 10, in block 86, calculates or estimates the 3D geometry of the external object based on the local surface normal N for each emitter using local smoothness estimates and edge detection. Then, the 3D geometry detection system 10 proceeds, in block 88 to calculate a depth map or 3D point cloud based on the estimated 3D geometry of the external object.

Using the depth map or 3D point cloud, the 3D geometry detection system 10 proceeds, in block 90, to compare the depth map or 3D point cloud with data stored in memory to detect a match between the object and stored data. The 3D geometry detection system 10 may then proceed, for example in block 92, to unlock access to an electronic device (e.g., the display device 12) in response to determining the calculated 3D geometry of the object corresponds to the stored data. The 3D geometry detection system 10 may further utilize, in block 94, the calculated 3D geometry of the object to recognize the object is consistent with a pre-programmed gesture based on the object's position or movement using the stored data.

Accordingly, aspects of embodiments of the present invention utilize emitters to illuminate external objects with a non-visible wavelength light from different positions or perspectives, while concurrently capturing images of the object for the purposes of calculated the 3D geometry of the external objects.

It will be recognized by those skilled in the art that various modifications may be made to the illustrated and other embodiments of the invention described above, without departing from the broad inventive step thereof. It will be understood therefore that the invention is not limited to the particular embodiments or arrangements disclosed, but is rather intended to cover any changes, adaptations or modifications which are within the scope and spirit of the invention as defined by the appended claims and their equivalents.

What is claimed is:

1. A display panel comprising:
a plurality of pixels configured to display an image;
at least one camera sensitive to a non-visible wavelength light and configured to have a field of view overlapping a front area of the display panel; and
a plurality of emitters configured to emit light having the non-visible wavelength light in synchronization with exposures of the at least one camera.

2. The display panel of claim 1, wherein the plurality of emitters are configured to simultaneously emit the non-visible wavelength light by a subset of the emitters.

3. The display panel of claim 2, wherein the plurality of emitters are configured to be turned-on and turned-off only.

4. The display panel of claim 1, wherein the at least one camera comprises a plurality of cameras.

5. The display panel of claim 4, wherein the plurality of cameras are located at opposite edges of the display panel.

6. The display panel of claim 1, wherein the at least one camera comprises a wide-angle lens camera.

7. The display panel of claim 1, further comprising a prism adjacent the at least one camera.

8. The display panel of claim 1, further comprising a processor configured to use images captured from the at least one camera to estimate a 3D geometry of an external object.

9. The display panel of claim 8, wherein the processor is configured to estimate the 3D geometry of the object using shadings in the images of the object generated by the non-visible wavelength light from the emitters.

10. The display panel of claim 1, wherein there are a greater number of the pixels than the emitters.

11. The display panel of claim 1, wherein the at least one camera is configured for the field of view to extend in a direction generally parallel to a front surface of the display panel.

12. The display panel of claim 1, wherein at least one of the emitters is positioned at a display area comprising the pixels.

13. The display panel of claim 1, wherein at least one of the emitters is positioned at a periphery region of the display panel outside a display area comprising the pixels.

14. A method of estimating a 3D geometry of an object in front of a display panel comprising at least one camera sensitive to a non-visible wavelength light, a plurality of display pixels and a plurality of emitters configured to emit the non-visible wavelength light, the method comprising:
illuminating the object with the non-visible wavelength light from the emitters in synchronization with exposures of the at least one camera;
capturing non-visible wavelength light images of the object utilizing the at least one camera; and
estimating the 3D geometry of the object utilizing the non-visible wavelength light images.

15. The method of estimating the 3D geometry of claim 14, wherein the illuminating the object comprises emitting the non-visible wavelength light from subsets of the emitters located at different areas of the display panel.

16. The method of estimating the 3D geometry of claim 15, wherein the object comprises an iris of an eye, and wherein the emitting of the non-visible wavelength light comprises emitting the non-visible wavelength light by the subsets of the emitters located at the different areas of the display panel to determine whether the iris matches a stored biometric data.

17. The method of estimating the 3D geometry of claim 15, wherein the emitters are grouped into different subsets at different times.

18. The method of estimating the 3D geometry of claim 14, wherein the non-visible wavelength light images of the object are captured while the plurality of display pixels are being used to display images unrelated to the object.

19. The method of estimating the 3D geometry of claim 14, wherein the estimating the 3D geometry of the object comprises interpreting shading gradients of the object in the non-visible wavelength light images as 3D depths.

20. The method of estimating the 3D geometry of claim 14, wherein the at least one camera comprises two cameras that are located at opposite edges of the display panel, and wherein the capturing the non-visible wavelength light images comprises capturing the non-visible wavelength light images simultaneously at the two cameras.

21. The method of estimating the 3D geometry of claim 14, wherein the at least one camera comprises a field of view extending in a direction generally parallel to a front surface of the display panel.

22. The method of estimating the 3D geometry of claim 14, wherein the at least one camera comprises a field of view extending in a direction generally perpendicular to a front surface of the display panel.

23. The method of estimating the 3D geometry of claim 14, further comprising:
comparing the estimated 3D geometry of the object with stored data; and
determining whether the estimated 3D geometry of the object matches the stored data for biometrically identifying the object.

24. The method of estimating the 3D geometry of claim 23, wherein the stored data comprises a data representation of a three-dimensional estimation of a user's face.

25. The method of estimating the 3D geometry of claim 23, further comprising unlocking access to an electronic device in response to determining the estimated 3D geometry of the object matches the stored data.

26. The method of estimating the 3D geometry of claim 14, further comprising determining whether the object comprises a three-dimensional object or a two-dimensional image of the three-dimensional object.
